(19) United States
(12) Patent Application Publication
(10) Pub. No.: US 2005/0050151 A1
(43) Pub. Date: Mar. 3, 2005

(54) Scalable instant messaging architecture

(75) Inventors: Pablo Andrew Mitchell, Berkeley, CA (US); Angela C. Teng, San Carlos, CA (US)

Correspondence Address: BANNER & WITCOFF AND ATTORNEYS FOR ACCENTURE, 10 S. WACKER DRIVE, 30TH FLOOR, CHICAGO, IL, 60606, US

(73) Assignee: Accenture Global Services GmbH, Schaffhausen (CH)

(21) Appl. No.: 10/651,032

(22) Filed: Aug. 29, 2003

(51) Int. Cl. G06F 15/16

(52) U.S. Cl. 709/207; 709/204; 719/318

(57) ABSTRACT

An instant messaging software architecture and method for implementing scalable and portable community-motivated communications is disclosed herein. Aspects of the invention can be used to enhance a user's instant messaging experience through the ability to involve a large number of users in a variety of different interactive environments while maintaining inter-user responsiveness. The scalability aspect of the invention utilizes scalable messaging interfaces and object oriented programming to extend user limits beyond current boundaries. The portability of this implementation and programming language also enables users of different devices such as PDAs, personal computers and mobile phones to use the same software and architecture to communicate with other users. Aspects of the invention further enable content providers to advertise, poll and otherwise interact with a large audience in a real-time instant messaging environment.

### FIELD OF THE INVENTION

The invention relates generally to communication through instant messaging technology. More specifically, the invention provides a method and network architecture for instantly communicating with a community of users at the same time and exhibiting adaptive behavior based on the community of users.

### BACKGROUND OF THE INVENTION

Instant messaging technology has grown rapidly as a popular method of communicating and keeping in touch with friends or relatives over long distances or even across the street. Instant messaging technology is often implemented through a graphical interface consisting of a list of friends or contacts (commonly referred to as a “buddy list”) and a chat window. Through the buddy list and chat window, users are able to initiate one-to-one conversations with another user or create a chatroom with several people. Instant messaging also allows a user to send and receive data, audio and image files through its interface.

Since its inception, instant messaging technology has grown significantly, encompassing more than just personal use. For example, instant messaging has expanded to include marketing and research applications. As a result, instant messaging developers engineered automated instant messaging buddies, also known as “bots”, that are able to communicate and interact with other users without significant human intervention or control. In order to engage the bot, a user adds the bot to his or her contact list, and opens a chat window with the bot. The user may then proceed to chat or interact with the automated buddy. Currently, automated buddies are used for several tasks from general chatting to reporting the weather to playing games.

Although current instant messaging architectures have excelled in implementing bots for one-to-one functionality, known instant messaging architectures have not provided a viable means for bots to provide a multi-user experience. While current bots are able to communicate with and engage several different users at once, the instant messaging architecture is unable to adapt a bot's response or performance for one user based on the bot's interaction with another user. For example, a user interacting with a trivia question bot will not feel the game is competitive because the trivia bot does not detect if another user has already answered the question correctly and adapt by preventing the first user from answering the question. As a result, an automated instant messaging bot is not capable of constructing an interactive community.

Other instant messaging architectures have been implemented through services such as Internet Relay Chat (“IRC”). IRC allows users to enter chatrooms, also known as “channels”, and interact with other users. IRC has also developed the ability to integrate bots into the channels to further promote file sharing and interaction. IRC bots often engage users through trivia questions, and awards points based on a first-person-to-answer-correctly methodology. The bots are also able to maintain a score sheet, tabulating each participating user's point total. In this way, IRC bots do build a sense of community and competition within the IRC world. However, IRC falls short in the fields of portability and overhead. While IRC excels on a personal computer platform, converting it to run on portable mediums significantly reduces IRC's functionality. Portability issues are also a problem because IRC clients are very much platform dependent. Furthermore, IRC must be run in the foreground in order for users to detect invitations to play games like trivia and therefore, requires a user's undivided attention from the screen and program. While IRC architectures may create a sense of internet community, there are inherent limitations in portability, scalability and overhead that hinder the experience.

An obstacle behind building an IM community lies in the capabilities of the messaging architecture. Current IM architectures are unable to support significant numbers of users. Thus, it is virtually impossible for bots to receive information from all users and then further adapt its responses to each individual user.

What this lack of community means is that users of instant messaging are limited to very individualized experiences in a messaging world containing hundreds of thousands of other users. Furthermore, businesses and other organizations are hindered from utilizing this technology to more effectively adapt their advertising and marketing strategies. For example, a bot programmed to send out free samples of music could not automatically adapt its music choice according to specific age groups or other demographics. Users, as much as businesses and organizations, are hurt by this lack of community because their preferences and ideas are not being shared throughout the instant messaging world and more importantly, they are not receiving information which interests them. Thus, it would be an advancement in the art to provide a scalable, portable and platform independent instant messaging network architecture that would expand the functionality and scope of instant messaging to overcome the limitations described above.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to creating an instant messaging system able to accommodate and interact with a community of users beyond the limits of previous systems.

A first aspect of the invention provides a portable and scalable instant messaging network architecture that includes a scheduler object, a program object, an automated instant messaging bot entity and a plurality of buddy objects. One of the scheduler object's responsibilities is to keep track of event times. When an event time has been reached, a trigger may fire telling the scheduler object to retrieve from an event database the event information received from a content provider, create a program object to handle this event, and pass the event information to the program object. Upon receiving the event data, the program object may create a solicitation or invitation to potential user participants if the event data so indicates. The program object may also instantiate an automated instant messaging bot entity to manage communications between participants and the event. The automated instant messaging bot entity, in order to handle communications, may further instantiate a buddy object for each participant of the event. Because the use of objects is prevalent in many platform independent languages, this aspect of the invention provides significant portability. Other platforms like PDAs and mobile phones will be able to communicate and use the same network architecture as does a powerful personal computer. To further coordinate communications, the automated instant messaging entity may also comprise scalable outbound and inbound messaging service interface queues. The scalability of the messaging system allows a significant amount of users to communicate at one time. Because the architecture is object oriented and because of the scalability of the interface queues, the present invention overcomes the limitations of previous designs.

A second aspect of the invention provides a method for coordinating and maintaining communications between discrete communities of users. The method comprises steps for retrieving data from a database and instantiating a program object based on the event data, creating an automated instant messaging bot entity, receiving a list of possible participants and sending a solicitation message to the list of possible participants. There exist several methods by which a list of possible participants may be retrieved including using an instant messaging identifier or user demographics. By receiving a list of possible participants, the method allows the event to maintain a community presence and atmosphere. The solicitation message may be an invitation or a general broadcast informing users of the upcoming event, and may be sent on a communications channel other than via instant messaging. Users may also be given a choice of participating through the solicitation or a different greeting message. The automated instant messaging bot entity further manages communications with participants of an event in several ways. When any communication passes through the automated bot entity, the bot entity may evaluate the incoming or outgoing message and adapt its responses or subsequent actions accordingly.

These and other aspects, features and advantages of the present invention will be apparent upon consideration of the following detailed description thereof, presented in connection with the following drawings, which are included by way of example, and not by way of limitation with regard to the claimed invention in which like reference numerals identifying the elements throughout.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 shows a block diagram of a computer used in an illustrative embodiment of the invention.

FIG. 2 illustrates a network architecture according to an illustrative embodiment of the invention.

FIG. 3 illustrates a user interface according to an illustrative embodiment of the invention.

FIG. 4A illustrates a block diagram of a process for inputting, scheduling and triggering events according to an illustrative embodiment of the invention.

FIG. 4B illustrates a block diagram of a process for communicating and interacting with users according to an illustrative embodiment of the invention.

FIG. 4C illustrates a block diagram of a process for handling incoming and outgoing messages and commands according to an illustrative embodiment of the invention.

FIG. 5 illustrates a message object according to an illustrative embodiment of the invention.

FIG. 6 illustrates a web interface for inputting event data according to an illustrative embodiment of the invention.

FIG. 7 illustrates a block diagram of a computer readable medium according to an illustrative embodiment of the invention.

### DETAILED DESCRIPTION OF THE INVENTION

The invention and the embodiments of the invention described herein provide a significant improvement over current messaging technology in building an adaptive online community. Each figure illustrates an aspect of the invention in a plurality of embodiments. Various embodiments of the invention provide high flexibility and inherent portability and therefore are not restricted by programming language, platform or electronic device. Aspects of the invention further make use of scalable interfaces to exceed the limitations of current scalability boundaries providing a richer community-motivated instant messaging experience.

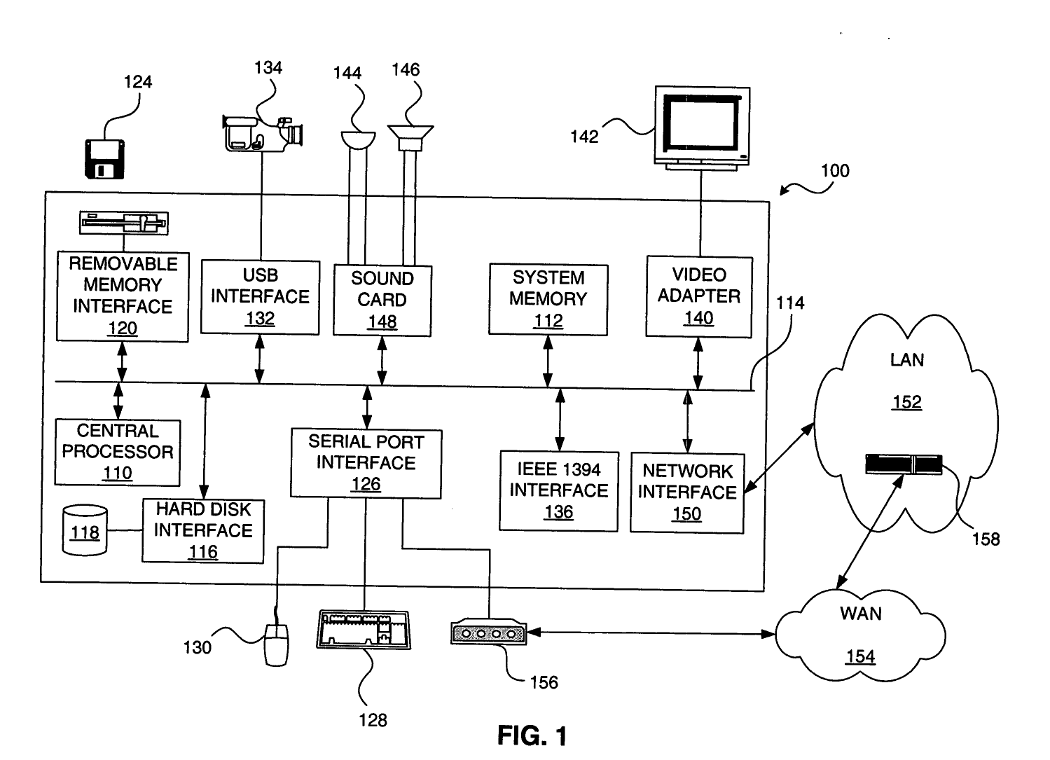

One or more aspects of the invention may be embodied in one or more computers and computer systems, such as is illustrated in FIG. 1. In FIG. 1, computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 130 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USB) interface 132 coupling a video or digital camera 134 to system bus 114. An IEEE 1394 interface 136 may be used to couple additional devices to computer 100. Furthermore, interface 136 may be configured to operate with particular manufacturer interfaces such as FireWire developed by Apple Computer and i.Link developed by Sony. Input devices may also be coupled to system bus 114 through a parallel port, a game port, a PCI board or any other interface used to couple an input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 146. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules stored on computer-readable media, such as hard disk 118, removable storage 124, system memory 112, and the like. Examples of program modules are routines, programs, objects, components, data structures, libraries etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants, mobile telephones and the like. Furthermore, the invention may also be practiced in distributed computing environments where tasks are performed by remote processing devices that are linked through a wireless or wired communications network. In a distributed computing environment, program modules may be located in both local and remote memory storage devices.

Network Architecture

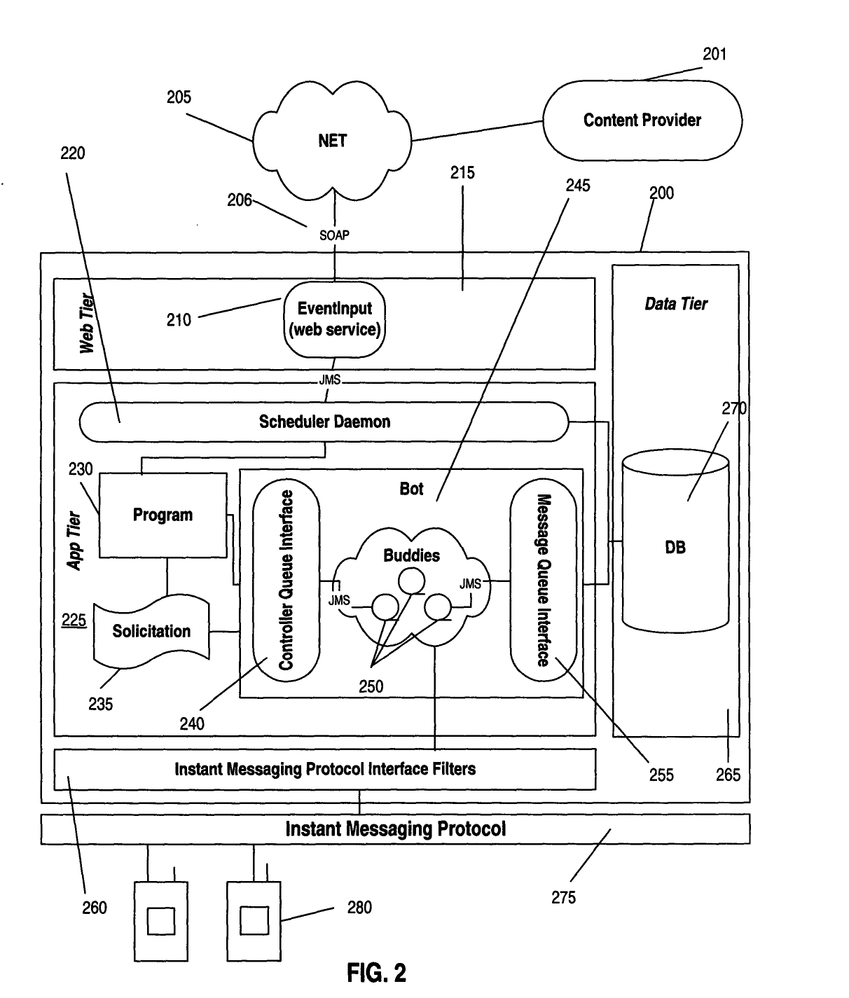

FIG. 2 illustrates a network architecture according to an illustrative embodiment of the invention. The network architecture may be housed in a central server, such as a computer 100 (FIG. 1), for an automated instant messaging entity and may control, among other things, programming and networking related tasks. Through the architecture, content provider(s) 201 are able to connect to the automated instant messaging system 200 through a network such as the Internet 205 and the interface's web tier 215. Thus, a content provider 201 may submit an event through the network 205 by way of a protocol such as a simple object access protocol (SOAP) 206 to the web tier 215 of the automated system 200. Events are usually a set of instructions that may be programmed to run at a certain time or under certain circumstances and may also interact with users. Some examples of an event may include advertisements, games and marketing or political polls. Generally, entities and organizations that need a community presence or response would be most likely to use an automated service like an instant messaging system as described herein.

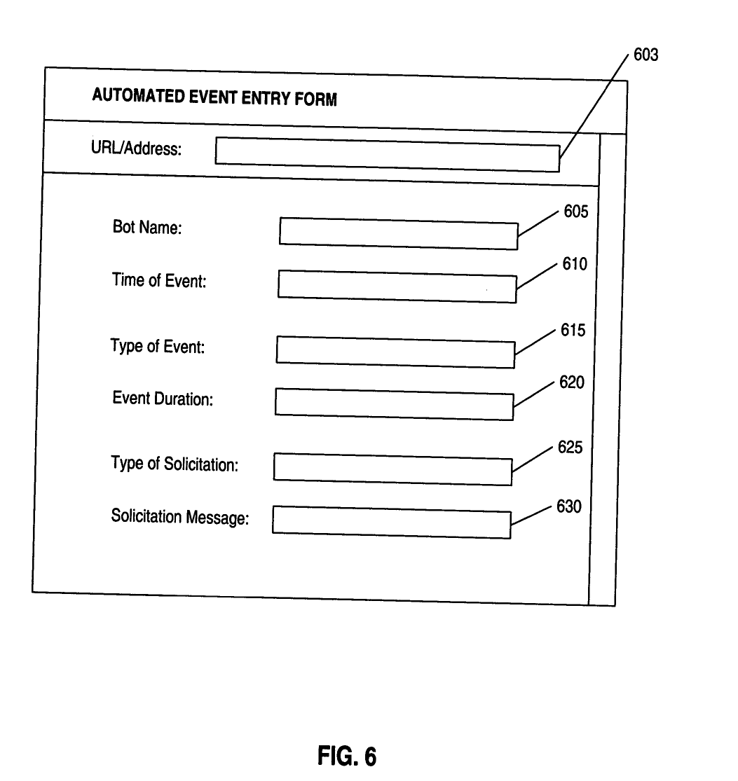

The automated instant messaging system 200 may comprise several components including the web tier 215, an application tier 225, an instant messaging filter module 260 and a database tier 265. The web tier 215 provides an input method for content provider(s) 201 to schedule and/or submit events. One input method may comprise a web service 210, a function, a program or an application. For example, a recording company may want to create an automated instant messaging entity to send participating users samples of its latest hit single. The recording company may then access a website interface of the web service 210 where it can enter the necessary specifications, and upload music samples, to create such an entity. FIG. 6 illustrates a sample web page through which a content provider can submit an event to the IM scheduler (described below). Some relevant information may be the date of advertisement or disbursement 610, duration of the sampling 620 and a solicitation message for the event 630. Other information that may be pertinent includes an identifier for the automated entity 605, the type of event 615 and a type of solicitation 625. For example, an event provider may want to initiate a music sampling event with the bot name “Music4You”. In such an instance, this bot name may be entered in the web page entry form 605. Types of solicitation include different forms of data (e.g., images, sounds) as well as whether a response is necessary. It will be appreciated by those of ordinary skill in the art that FIG. 6 is illustrative in nature, and that event submission information may include more, less, or different types of data. Upon receiving an event submission, the web tier 215 may then pass the event to the application tier 225 for processing.

The application tier 225 generally maintains and executes all functionality and tasks involved with an event. For example, the application tier 225 may be responsible for the timing of the event in addition to creating and processing message objects. If an event needs to send a message, the application tier 225 prepares the communication in a message object and passes it to the instant messaging filter module 260 for reformatting according to a particular instant messaging protocol 275. On the other hand, if a message is being received, the application tier 225 formats the data into a message object suitable for internal evaluation. The message is not limited to just text messages and may include other forms of data such as audio and video.

The application tier comprises several components including a scheduler daemon 220, a program module 230, a solicitation message 235 and a bot object 245. When an event object is passed into the application tier 225, the event object is directed to the scheduler daemon 220, which stores the event object in the database 270 and creates a trigger corresponding to the time of the event. When the trigger fires (i.e. is activated), the scheduler 220 may retrieve the data from the storage database 270 and send the information to program module 230. There may also be situations in which a content provider inputs a recurring event following a predefined schedule. In such a case, the scheduler daemon 220 may instantiate an instance of the event for each recurrence or trigger firing. After sending the event information to program module 230, the scheduler daemon's responsibilities for a particular event or instance of an event may end.

The program module 230 receives the event object and instructions upon trigger activation and subsequently instantiates a solicitation 235 (when required by the event) and a bot object 245. If the event object requires a tally of all statistical data collected, then these instructions are passed to the bot object 245 with the event data. One of the program module's 230 duties may be to create and send out a solicitation message 235 if the event object so requires. The solicitation 235 may be an invitation or an announcement that is broadcast once to participating users 280 when the trigger fires or shortly afterward. For instance, if a television questionnaire is scheduled to occur at 3:00 PM, the event object may indicate that an invitation should be sent to potential participants at 2:50 PM. The program module 230 may send the solicitation message through a communications channel other than instant messaging. For example, the program object may send an SMS message to potential participants, informing them of the upcoming event. Those users receiving the solicitation message that desire to participate can then turn on their instant messaging program on their communication device to participate in the event.

Responsibilities of the bot object 245 may include interacting with the subscribed users (e.g., those users that responded affirmatively to the solicitation) directly or through buddy objects (described below), receiving instructions from the program module 230, evaluating incoming communications, and formulating responses or other outgoing data. For example, the bot object 245 may control timing of questions and receive a series of answers and, in response, calculate percentages or statistics according to the event specifications. The bot object 245 is further comprised of a controller queue interface 240, a messaging queue interface 255 and a plurality of buddy objects 250. The controller queue interface 240 and messaging queue interface 255 utilize a messaging service with inherent scalability such as the Java Messaging Service (JMS) to send and receive messages or commands. This utilization of and interaction with a scalable messaging service like JMS, in addition to the delineation of communication tasks to discrete entities and/or objects, allows the architecture to expand beyond the limits of previous instant messaging network architectures. Upon activation, the bot object 245 may instantiate one or more buddy objects 250 corresponding to a list of individuals on its buddy list. Each buddy object 250 corresponds to a single participant 280 who is subscribed to the event or service, and that the bot object or its owner has added to the bot object's buddy list. The bot profile and buddy list may be retrieved from the instant messaging protocol 275 by specifying a particular user identifier corresponding to the bot object. The bot object acts as an intelligent automated user of the instant messaging service. Other methods of creating or obtaining a buddy list are by retrieving a predefined list managed by the content provider, matching users with a set of event criteria, or automatically formulating a list using a program algorithm or other heuristic. The buddy objects 250 may then receive solicitations 235 and other messages from the bot object 245 and pass them on to participants 280. For example, the bot object may send a “question” object to each buddy participating in a trivia contest. The question object may include a question and an associated correct response. The buddy objects then each send the question to their corresponding participant 280.

However, before the message is sent to the participants 280, the messages may be formatted, filtered and sent through a proper protocol. The buddy objects 250 may further be used as caching objects that store data pertinent to the specific individual (e.g., point totals, music preferences). The responsibilities of buddy object 250 may further comprise additional tasks. Some of these tasks may include keeping track of point totals, evaluating the accuracy of answers, or providing feedback or other information. For example, if an event involves an adaptive marketing poll, the buddy object 250 may be required to keep track of its respective participant's answers to questions. The buddy object 250 may further send this information for storage in the database for future use by the owner of the event. The bot object 245, after analyzing responses from users, may instruct the buddy object 250 to ask a specific question that is more suitable for the participant given the participant's previous answers.

At any point after the event is passed to the program module 230 and a bot 245 has been instantiated, any incoming or outgoing messages may pass through the protocol filters 260 for a message conformity check. The filter module 260 may ensure that outgoing messages are in the proper format for a particular instant messaging protocol 275 corresponding to a specific participant 280. The filter module 260 is an extensible structure, able to determine and apply an appropriate protocol filter selected from a plurality of filters for each participant. Furthermore, the architecture may be adapted to other instant messaging protocols by adding an additional filter in the filter module 260. For example, if a company wants to adapt its automated marketing survey messenger to work with a newly developed instant messenger protocol, the company may create a new filter based on the new instant messenger's protocol. Upon performing the filter operations and passing through the instant messaging protocol 275, a message may reach a communications device 280 such as a mobile phone, PDA, or computer system. Alternatively, a specific instance of a bot object 245 may be hard-coded for a specific instant messaging protocol 275, negating the need to use filters 260, but limiting participants 280 to those users within that specific instant messaging protocol 275.

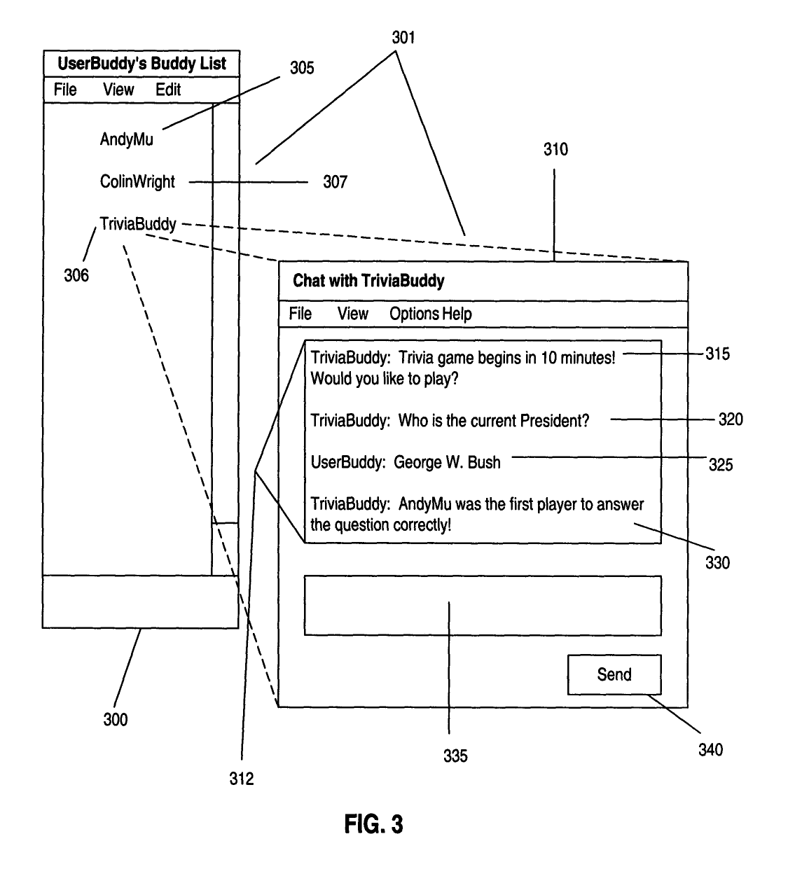

FIG. 3 illustrates a user interface 301 for participants and users according to an illustrative embodiment of the invention. The user interface 301 may comprise two components: a contacts window (“Buddy List”) 300 comprising a list of friends' names (“buddies”) 305-307 and one or more chat window(s) 310. A user may activate a chat window 310 by selecting a name 305 from the Buddy List 300. The user may then send a message by entering text or data in the entry field 335 and selecting the send option 340. In one embodiment of the invention, a participant interacts with an automated messaging buddy 306 through such a user interface 301. Generally, the automated buddy initiates a dialogue 312 with the participant by sending a greeting message 315 for an event. The greeting 315 may or may not require a response from each participant. If a response is required, and a user either responds negatively or not at all, then the bot object may remove the buddy object corresponding to that user so that there is no longer a communication channel (e.g., socket) open to communicate with that user for the duration of the event. At the predetermined time, the automated buddy 306 would start the event. In this example, TriviaBuddy, the automated messaging buddy 306, starts a trivia game by asking the first question 320. A first participant 305 may then respond by answering the question 325 or the first participant 305 may simply ignore the question. Depending on the first participant's response and response time, the automated buddy 306 may communicate with the first participant 305 appropriately. For example, if a second participant 307 answers the question correctly before the first participant 305 does, TriviaBuddy may send out a message 330 indicating the status of the current question 320. Participants may also interact with an automated buddy in a plethora of other ways, including requesting point totals, event standings and poll results. In some embodiments of the invention, a point total corresponding to correctly answered questions is maintained for each user without preventing a user from answering a question after another user has lready correctly answered that question. While the user interface 301 in this embodiment of the invention is typical of instant messengers, the network architecture underlying the automated buddy and message-handling protocol is significantly improved.

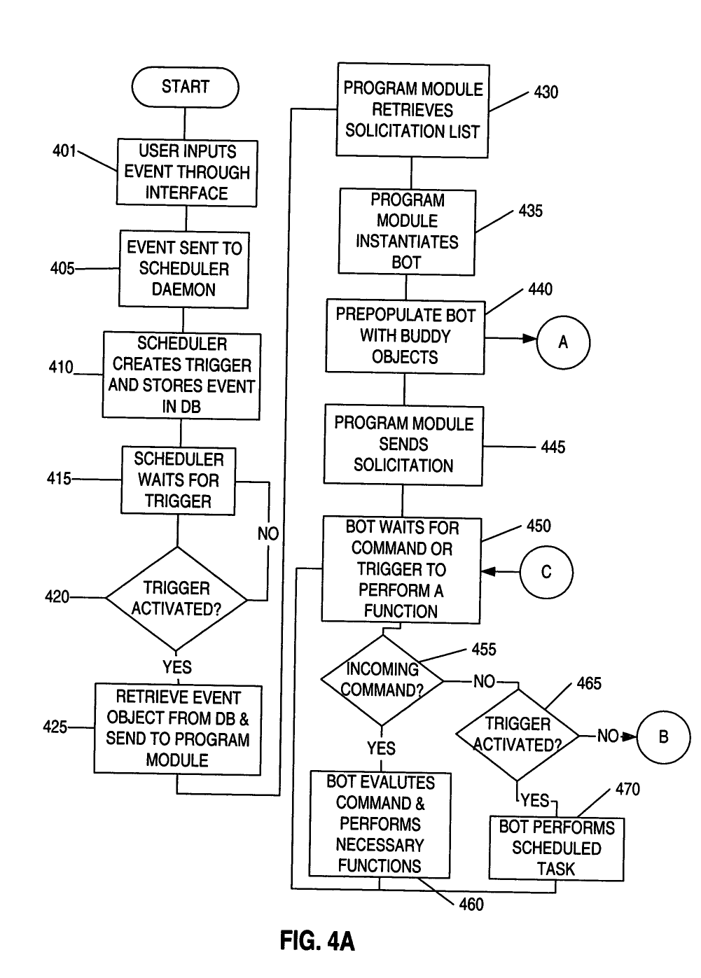

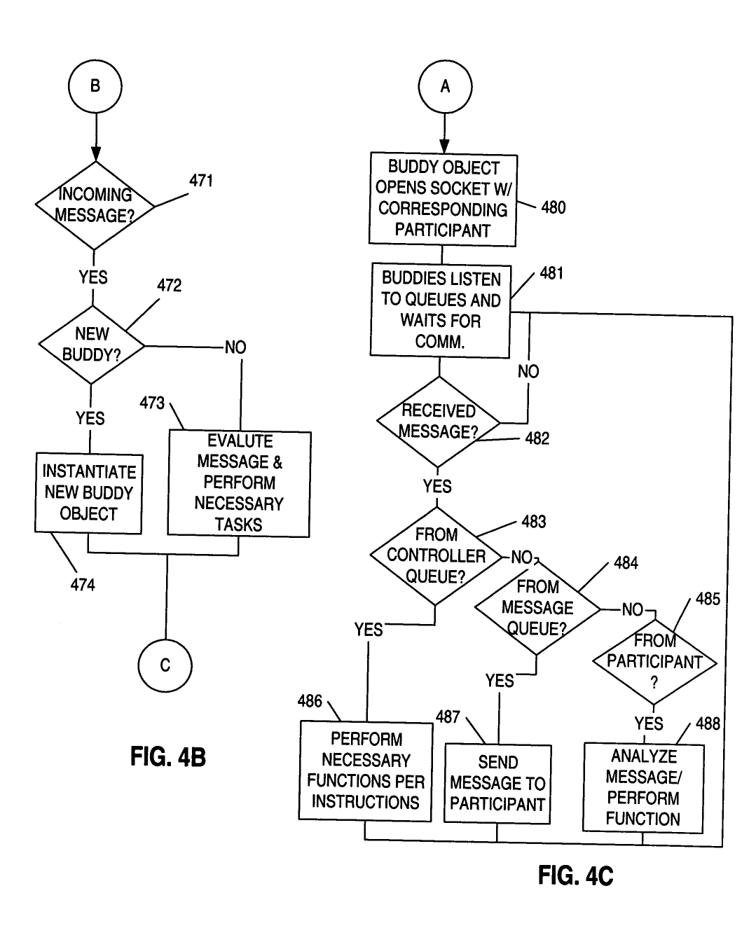

FIG. 4A illustrates a block diagram of a process for inputting, scheduling and triggering events using the architecture of FIG. 2 according to an illustrative embodiment of the invention. Initially, in step 401, an administrative user may input an event through an interface located in the web tier 215. The input interface 210 may comprise a web form or a web application. Administrative users are able to enter event relevant information such as start time, end time, solicitation message, type of event, participant criteria, and the like.

After an administrator has entered the event information into the web tier 215, the input interface sends the event to the scheduler daemon 220 in the application tier 225, as illustrated in step 405. Upon receipt of the event data, in step 410 the scheduler daemon 220 creates a trigger that specifies the start time of the solicitation or event. The scheduler daemon 220 then stores the event object in a database 270 in the database tier 265. The trigger may also contain information corresponding the trigger to the proper event in the database 270. In steps 415 and 420, the scheduler daemon 220 waits, evaluating the activation status of each trigger. Upon trigger activation, the scheduler daemon 220 retrieves the corresponding event object from the database 270 and sends it to the program module 230, as is shown in step 425. The program module 230 may also retrieve the event data after being instantiated by the scheduler daemon 220. That is, instead of retrieving and passing the event data to the program module 230 itself, the scheduler daemon 220 may instead send event data location and identification information to the program module 230 for the program module 230 to retrieve.

In step 430, the program module 230, after receiving the event object, may retrieve a buddy list using an instant messaging protocol 275. Instant messaging protocols 275 typically store a buddy list constructed by a particular user by associating the list with the particular user's instant messaging identifier. In the case of a user identifier consistently used by a particular content provider or an event, the user identifier may be stored in the event object to indicate a specific predefined buddy list to retrieve. In alternative arrangements of the invention, the buddy list may be constructed based on a set of users whose user profiles match a set of event criteria. Other algorithms may also be used in constructing the buddy list.

In step 435, the program module 230 instantiates a bot object 245 to handle all buddy correspondences. Thereafter, any message to or from a participant 280 would first pass through the bot object 245. In step 440, the bot object instantiates one buddy object 250 per contact in a list of participants selected from the retrieved buddy list. Generally, the participant list may comprise the entire retrieved buddy list or only those users from the buddy list that provided a positive response to the solicitation 235 or the greeting message 315. The participant list construction method may also depend on whether the event data requires a response to the invitation or solicitation 235 or greeting 315. Other methods may also be used to select a list of participants from the retrieved buddy list such as using demographic specifications. Any predetermined list may alternatively be used.

After prepopulation, the program module 230 constructs a solicitation 235 according to the instructions in the event object in step 445. This solicitation 235 may be sent through a separate communication channel, e.g., SMS as discussed above, or may be sent through the IM service. If sent through the IM service, the solicitation may be placed on the controller interface 240 for direct delivery to the participants 280, or may be placed on the message interface queue 255 for delivery to the participants by the respective bot objects. If the solicitation is sent through the separate communication channel such as SMS, then the solicitation is more likely to reach potential participants when their communication devices are on but their instant messaging applications are not running, whereas when the solicitation is sent through the IM service, users who are not running an IM client will not receive the solicitation. However, in some embodiments, the bot and buddy objects are not instantiated until shortly prior to when the event is scheduled to begin, in which case the solicitation is sent through the separate communication channel such as SMS.

In step 450, the bot object 245 waits for the activation of a trigger corresponding to a scheduled task specified by the event (e.g., sending a trivia or survey question). Examples of scheduled tasks may include querying a user or users, reporting results to a participant or notifying participants of the end of the event. The bot object 230 may also perform certain jobs through the controller queue interface 240 as shown in step 460. For example, the bot object 245, through the controller queue 240, may send out an advertisement for an upcoming event. Since the initial trigger in the scheduler daemon 220 and program module 230 might only indicate the event's begin time, the bot object 245 may also have a scheduler of its own to handle sub-events within the event as well as other temporal issues such as time intervals between queries (e.g., trivia questions, surveys, etc.) or advertisements. In steps 455 and 465, the bot may monitor the controller queue 240 to check if there is either an incoming command or trigger activation. In the event of a bot object trigger activation, as shown in step 470, the bot object may perform a scheduled task. For example, a trigger in the bot object 230 may activate indicating that it is time to send out the next question of a marketing survey.

With reference to FIG. 4B, after the program module 230 instantiates a bot object 245, the bot object 245 may manage inbound and outbound communications independently from the program module 230. In step 471, after instantiation, the bot 245 enters a listening mode where it waits for messages or other communications. If the message originates from a participant 280 by way of the buddy objects 250, the bot object 245 evaluates the message contents. In steps 472 and 474, if the message specifies a new buddy signing onto the service, the bot 245 may then instantiate a new buddy object 250 associated with the new participant 280. In step 473, other messages not relevant to a new buddy presence are evaluated by the bot object 245. If there is such a message in the message queue 255, the bot object 245 may refer to the event object instructions to evaluate the message and perform any necessary functions. For example, if a participant 280 answers a trivia question, the bot object 245, following the event object instructions, may evaluate the accuracy of the answer and perform an associated function such as respond with an appropriate message or adjust point totals in the database 270. After resolving either an outbound or inbound message or command, the bot object 245 subsequently returns to a listening mode.

With reference to FIG. 4C, upon buddy object 250 instantiation in step 440, each buddy object 250 may be responsible for the participant 280 it represents. To do so, in step 480, each buddy object may create a separate communications socket between itself and its corresponding participant 280. The communications socket may be specific to the instant messaging protocol 275 to facilitate message management, transmission, and receiving. The socket will typically stay active until the participant 280 either chooses to end his or her participation or logs off the instant messaging network. After establishing a socket with a participant 280, the buddy object 250 may listen to the message queue 255 and controller queue 240 for communications or instructions, as shown in step 481. If a message is received in step 482, the buddy object 250 may discern the message's origin. Depending on whether the message is incoming or outgoing, the buddy objects 250 may be responsible for placing the message on the message queue interface 255 or taking it off the queue 255 and transmitting it to the participants 280 through the socket. If the message is on the controller queue 250 as in step 483 and 486, the buddy object 250 may perform the necessary functions per the instructions in the message. However, if the message originated from the message queue 255, the buddy object 250 may send the message to the participant 280, as shown in steps 484 and 487. Finally, in steps 485 and 488, if the message is from a participant 280, the buddy object 250 may place the message on the message queue 255 for the bot object to pick up.

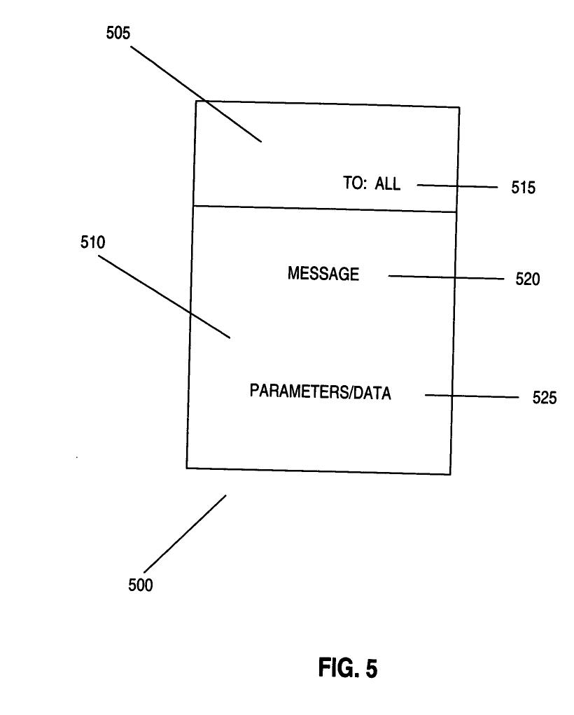

Messages sent from the program module or received by the bot object 245 are instantiated within message objects 500 as shown in FIG. 5. These message objects 500 are comprised of a header section 505 and a data/message section 510. Since the message objects 500 are placed on a queue 240 or 255 (FIG. 2), buddies 250 (FIG. 2) require a method of evaluating the message's relevance. Therefore, the header section 505 of the message object 500 may contain a recipient field 515 where targeted buddies 250 of the message may be specified. The message portion 520 may be contained within the data section 525. Other information may also be specified within the data section 525 including additional parameters or restrictions. For example, in addition to the text of the message, the data/message section 510 could further comprise an encryption indicator necessary to read a message. The message object 500 is a highly flexible structure, able to support many parameters and message types including music files and video files.

The combination of a scalable messaging service such as JMS, in combination with the clear delineation and distribution of tasks to the various objects and entities of the invention provides inherent scalability of the instant messaging architecture provided herein. Using this messaging service to provide trivia game, interactive surveys, and the like to numerous participating users requires significant data handling capabilities. A messaging service like JMS applies network data distribution patterns that are able to alleviate problems with load balancing and process stability. The JMS interface is also advantageous because JAVA is generally platform independent and therefore may expand the portability of such a network architecture. Due to both the scalability and portability of this network architecture, it is possible to use instant messaging in novel ways. With such a network, bot events and programs will be able to offer a sense of community and competition among participants. Non-traditional media like television may use this architecture to accomplish its own goals. For example, a television station dedicated to playing music and music videos may poll its participants to determine what video to play next or it may be able to offer certain products to particular viewers based on a collection of demographic data. The portability of this architecture also enables less powerful devices like personal digital assistants (PDA) and mobile phones to realize the expanded functionality of instant messaging.

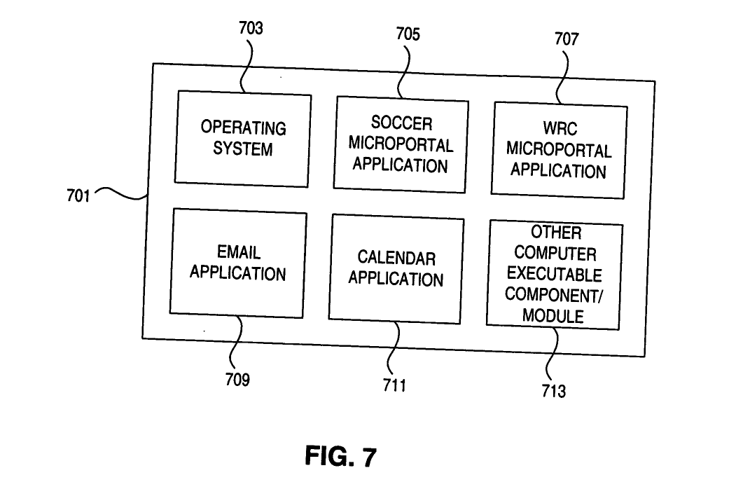

The inventive methods may be embodied as computer readable instructions stored on a computer readable medium such as a floppy disk, CD-ROM, removable storage device, hard disk, system memory, embedded memory or other data storage medium. FIG. 7 illustrates a block diagram of a computer readable medium 701 that may be used in accordance with one or more of the above-described embodiments. The computer readable medium 701 stores computer executable components, or software modules, 703-713. More or fewer software modules may alternatively be used. Each component may be an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings of the present invention.

While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

1. A scalable instant messaging system comprising:
a scheduler object that retrieves, when an event trigger fires at a predetermined event time, event data from a database object;
a program object that manages event tasks defined by the event data;
an automated event bot, wherein the automated event bot manages communications with a plurality of participants of the event based on the event tasks;
a buddy object for each unique participant of the event, each buddy object being managed by the automated event bot.

2. The system of claim 1, wherein the program object is instantiated by the scheduler object based on the event data.

3. The system of claim 1, wherein the automated event bot is instantiated by the program object based on the event data.

4. The system of claim 1, wherein the program object constructs and transmits a solicitation for the event to a predetermined set of possible participants through a communication channel other than an instant messenger service.

5. The system of claim 1, wherein the automated event bot comprises a controller queue interface for providing commands to the buddy objects, and a message queue interface for providing message data to the buddy objects.

6. The system of claim 1, further comprising an instant messaging protocol interface filter module for modifying a message according to an instant messaging protocol of a receiving participant.

7. The system of claim 6, wherein the instant messaging protocol interface filter module further comprises one or more protocol filters, each specific to a particular instant messaging protocol.

8. A method for coordinating and maintaining communications between a community of users, comprising:
when an event trigger fires, retrieving event data from a database and instantiating a program object based on the event data;
creating an automated event bot for managing instant messaging communications with participants of an event corresponding to the event data;
receiving a predetermined first list of users representing possible participants for the event; and
sending a solicitation message, via a communication channel other than an instant messaging service, to each user in the first list of users.

9. The method of claim 8, further comprising the automated event bot instantiating a buddy object for each user in a second list of users comprising users selected from the first list of users.

10. The method of claim 9, wherein the second list of users comprises users from the first list of users from which a positive response to a greeting message is received.

11. The method of claim 9, wherein the second list of users comprises all users from the first list of users.

12. The method of claim 8, further comprising sending, at a predetermined time, an event message to one or more users for which there exists a buddy object, when information stored in the user's respective buddy object matches a criteria of the event message.

13. The method of claim 9, wherein the buddy objects receive and process response messages from the participants based on data received from the event bot.

14. The method of claim 9, wherein the buddy objects compose and send messages to one or more participants based on instructions received from the automated event bot.

15. The method of claim 8, wherein the step of receiving a predetermined first list of users representing possible participants for the event comprises retrieving a list of users from an instant messaging protocol corresponding to a predefined user identifier.

16. The method of claim 9, further comprising sending a greeting message to each user for which there exists a corresponding buddy object, wherein the greeting message requests a response identifying each user's desire to participate in the event.

17. The method of claim 16, wherein when no response or a negative response is received from a particular user, the automated event bot removes the buddy object corresponding to the particular user.

18. The method of claim 12, wherein the step of sending, at a predetermined time, an event message to one or more users for which there exists a buddy object, when information stored in the user's respective buddy object matches a criteria of the event message, comprises:
sending an event message in response to a communication received from a participant

19. The method of claim 12, wherein the step of sending, at a predetermined time, an event message to one or more users for which there exists a buddy object, when information stored in the user's respective buddy object matches a criteria of the event message, comprises:
storing event data relevant to a particular user in the particular user's representative buddy object.

20. A computer readable medium storing computer executable instructions that, when run, create a software architecture comprising:
a program object, instantiated by a scheduler object when an event trigger fires, wherein the program object receives an event ID and retrieves event information from an event database based on the received event ID;
an automated event bot instantiated by the program object based on the event data, wherein the automated event bot manages event activities for a plurality of clients participating in the event; and
a buddy object instantiated by the automated event bot for each of the plurality of clients participating in the event, wherein each buddy object maintains an instant messaging socket with its corresponding client.

21. The computer readable medium of claim 20, wherein the software architecture further comprises:
a solicitation message generated and sent by the program object over a communication channel other than the instant messaging system for which the buddy objects maintain instant messaging sockets.

22. The computer readable medium of claim 20, wherein the software architecture further comprises a greeting message generated and sent by the automated event bot to a plurality of clients, wherein the greeting message requests a response regarding each client's desire to participate in the event.

23. The computer readable medium of claim 22, wherein when the automated event bot receives no response or a negative response from a particular client responsive to the greeting message, the automated event bot removes the buddy object corresponding to the particular client.

24. The computer readable medium of claim 20, wherein the automated event bot passes a message object having message data to one or more buddy objects via a message queue.

25. The computer readable medium of claim 24, wherein each of the one or more buddy objects that receive the message object generates and sends a message to its corresponding client based on the message data.

26. The computer readable medium of claim 25, wherein the message data comprises question data and answer data.

27. The computer readable medium of claim 26, wherein each buddy object, upon receiving a response from its corresponding client based on the message, evaluates the received response by a comparison of the response to the answer data.
